(19) United States
(12) Patent Application Publication
(10) Pub. No.: US 2013/0170685 A1
(43) Pub. Date: Jul. 4, 2013

(54) ELECTRONIC APPARATUS HAVING RESONANCE STRUCTURE FOR SPEAKER DEVICE

(71) Applicant: Samsung Electronics Co., Ltd., Gyeonggi-do (KR)

(72) Inventors: Eun-Young OH, Daegu (KR); Jee-Tae PARK, Gyeongsangbuk-do (KR)

(73) Assignee: SAMSUNG ELECTRONICS CO., LTD., Gyeonggi-do (KR)

(21) Appl. No.: 13/657,937

(22) Filed: Oct. 23, 2012

(30) Foreign Application Priority Data
Dec. 28, 2011 (KR) 10-2011-0144766

(51) Int. Cl. H04R 1/02

(52) U.S. Cl. 381/334; 381/332

(57) ABSTRACT

An electronic apparatus having a resonance structure for providing smooth resonance of a speaker sound of a speaker device is provided. The electronic apparatus includes an upper case frame, a lower case frame adapted to be joined with the upper case frame and have a sealing structure for joining the lower case frame and the upper case frame, a speaker device fixed to an inner surface of one of the upper case frame and the lower case frame, and a board electrically connected with speaker terminals of the speaker device when the upper case frame and the lower case frame are joined and, wherein a sealing space formed by the sealing structure creates a resonance space of the speaker device.

### CLAIM OF PRIORITY

This application claims the benefit under 35 U.S.C. §119(a) from a Korean patent application filed in the Korean Intellectual Property Office on Dec. 28, 2011 and assigned Serial No. 10-2011-0144766, the entire disclosure of which is hereby incorporated by reference in its entirety.

### BACKGROUND OF THE INVENTION

1. Field of the Invention

The present invention relates to an electronic apparatus having a resonance structure for providing smooth resonance of a speaker sound of a speaker device.

2. Description of the Related Art

In general, a speaker device operates by the interaction of a magnet and a diaphragm having a voice coil installed to have a certain gap with the magnet on a body having a certain cylindrical receiving part. When a driving signal is provided to the above-described voice coil, the voice coil rises or falls in a direction aligned with a magnetic force line of the magnet and a magnitude and direction of an electromagnetic force line of the voice coil. In response, the diaphragm vibrates together with the voice coil. That is, because sound pressure is generated when the above-described operation of the diaphragm is repeatedly performed, the speaker device outputs a sound of an audible frequency band. Accordingly, an electronic apparatus including the speaker device must have a space that is capable of receiving the sound pressure generated from the speaker device.

However, in order to meet demands of users, small-sized electronic apparatuses, such as a portable terminal for voice call and video telephony and an MPEG-1 Audio Layer 3 (MP3) player which use the above-described speaker device are continually providing a greater number and more diverse functions while being reduced in size.

In the case of portable terminals, a thin-type slim phone which minimizes the entire thickness of the portable terminal are becoming more prevalent. Such portable terminals are on a trend of minimizing the size of a variety of components mounted therein. In addition, recently, a typical portable terminal, commonly referred to as a “smartphone” includes a touch screen device. The touch screen device may be used as a display device, provide an interactive input device for providing access to the wireless Internet and may execute software including a variety of application programs such as a multimedia presentations and listening to music. The touch screen device may also perform data input and output simultaneously. In order to perform many of the above-described functions, a smartphone may also include a speaker device for outputting sounds, music and alarms.

If the above-described speaker device is applied to this electronic apparatus, a surface on which a speaker sound of the speaker device is emitted and a surface of a case frame of the electronic apparatus are generally positioned very close together. However, as described above, if the case frame of the electronic apparatus and the speaker device are located in close proximity, the air-hole, which is formed in a rear of the speaker device and allows for the movement of air in response to vibration of a diaphragm, and an inner surface of the case frame will not have a sufficient space between them. Accordingly, air is not smoothly emitted from the speaker device. For this reason, relatively low volume and sound quality are generated.

Accordingly, in order to generate desired sound pressure, the electronic apparatus is configured by placing the speaker device within an injection molded structure such as a separate carrier or enclosure in order to enclose the speaker within a structure and thus control and focus the sound waves output from the speaker in order to achieve a higher quality sound output.

However, there is a problem in that this configuration not only generates insufficient sound pressure for the speaker device but also this configuration is in contrast to the trend in an electronic apparatus toward slimness, lightness, thinness, and compactness, because the separate carrier adds additional structure and bulk to the electronic device.

### SUMMARY OF THE INVENTION

An exemplary aspect of the present invention is to solve at least the above-mentioned problems and/or disadvantages and to provide at least the advantages described below. Accordingly, an exemplary aspect of the present invention is to provide an electronic apparatus having a resonance structure for a speaker device, which has a structure for emitting a sound which has a higher quality than conventional quality using a speaker device of the same performance.

Another exemplary aspect of the present invention is to provide an electronic apparatus having a resonance structure for a speaker device, which is implemented to emit sound quality of desired performance having a simple structure using only components of the electronic apparatus without an additional component.

Another exemplary aspect of the present invention is to provide an electronic apparatus having a resonance structure for a speaker device, which is implemented to emit sound quality of desired performance using only basic components of the electronic apparatus and to maintain the compactness and slimness in the electronic apparatus.

Another exemplary aspect of the present invention is to provide an electronic apparatus or a portable terminal having a resonance structure for a speaker device, which is implemented to form a smooth resonance space of the speaker device using an airtight structure of the electronic apparatus.

In accordance with an exemplary aspect of the present invention, an electronic apparatus is provided. The electronic apparatus includes

an upper case frame; a lower case frame adapted to be joined with the upper case frame and have a sealing structure; a speaker device fixed to an inner surface of one of the upper case frame and the lower case frame; and a board electrically connected with speaker terminals of the speaker device when the upper case frame and the lower case frame are joined, and wherein a sealing space formed by the sealing structure creates is used as a resonance space of the speaker device.

In accordance with another exemplary aspect of the present invention, an electronic apparatus is provided. The electronic apparatus includes at least two case frames configured to have a sealing space therein when the case frames are joined and are adapted to incorporate an electronic apparatus within the at least two case frames; a board disposed in a space formed between the case frames; and a speaker device which is installed in one of the at least two case frames and is electrically connected with the board when the case frames are joined, wherein the sealing space formed by the case frames is used as a resonance space for the speaker device when the speaker device is operated.

In accordance with another exemplary aspect of the present invention, a resonance structure for a speaker device of an electronic apparatus is provided. The resonance structure includes a first case frame; a second case frame which is joined with the first case frame and are adapted to incorporate an electronic apparatus within the first case frame and the second case frame; a board disposed in a space formed by the first and second case frames; and a speaker device which is installed in one of the first and second case frames and has speaker terminals electrically connected with the board when the case frames are joined, wherein the space is formed as a sealing structure and wherein the space is used as a resonance space of the speaker device when the speaker device is operated.

### BRIEF DESCRIPTION OF THE DRAWINGS

The above and other exemplary aspects, features and advantages of certain exemplary embodiments of the ELECTRONIC APPARATUS HAVING RESONANCE STRUCTURE FOR SPEAKER DEVICE according to the present invention will become more apparent to a person of ordinary skill in the art from the following detailed description taken in conjunction with the accompanying drawings, in which:

FIG. 1 is a front perspective view of a portable terminal according to one exemplary embodiment of the present invention;

FIG. 2 is a rear perspective view of a portable terminal of FIG. 1 according to an exemplary embodiment of the present invention;

FIG. 3 is an exploded perspective view of a portable terminal showing a state where a speaker device of FIG. 1 is installed according to an exemplary embodiment of the present invention;

FIG. 4 is a cross section view of a part of a portable terminal showing a state where a speaker device of FIG. 1 is installed according to an exemplary embodiment of the present invention.

### DETAILED DESCRIPTION OF EXEMPLARY EMBODIMENTS

Exemplary embodiments of the present invention will now be described herein below with reference to the accompanying drawings. In the following description, well-known functions or constructions may not be described in detail when they would obscure the appreciation of the present invention by a person of ordinary skill in the art with unnecessary detail of the well-known functions and structures. Also, the terms used herein are defined according to the functions of the present invention as would be understood by a person of ordinary skill in the art. Thus, the terms may vary depending on user's or operator's intension and usage. That is, the terms used herein must be understood based on the descriptions made herein in view of the ordinary level of skill in the art.

In describing the present invention, hereinafter, the present invention provides a portable terminal for transmitting and receiving voices and images. However, it is clear that a speaker mounting structure according to the present invention may be applied to a variety of devices. For example, the speaker mounting structure may be applied to a variety of devices having a speaker device, such as for example a tablet Personal Computer (PC) or an MP3 player. The speaker mounting structure may also be applied to a speaker device provided in a device which is not a portable device. It is clear that the speaker mounting structure may be applied to a variety of electronic apparatuses which may form a speaker sound resonance space according to a case frame combination structure of the present invention.

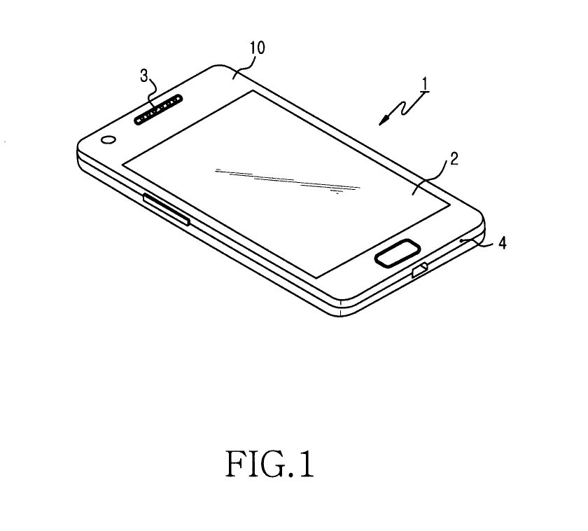

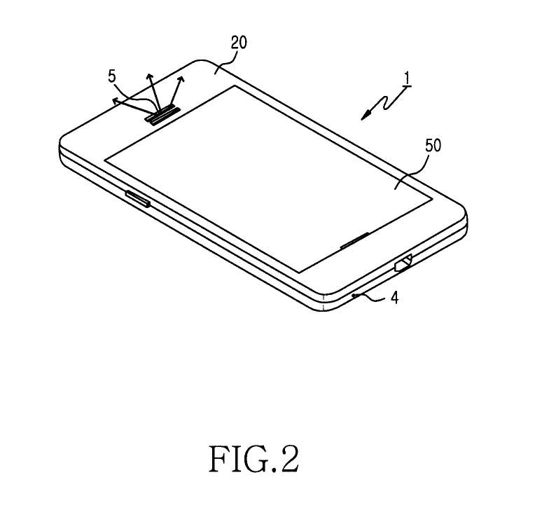

FIG. 1 is a front perspective view of a portable terminal according to an exemplary embodiment of the present invention. FIG. 2 is a rear perspective view of a portable terminal of FIG. 1 according to an exemplary embodiment of the present invention.

Referring now to FIG. 1 and FIG. 2, the portable terminal denoted by 1 according to one exemplary embodiment of the present invention includes an upper case frame 10 and a lower case frame 20. The upper case frame 10 and the lower case frame 20 forms the exterior housing of the portable terminal 1. A display device 2 is installed on a front surface of the portable terminal 1. An ear piece 3 for audio output of sound, such as for a voice call is installed above the display device 2. A microphone device 4 for audio input of sound, such as for a voice call is installed under the display device 2. Preferably, the display device 2 may be a touch screen device which performs data input and output simultaneously.

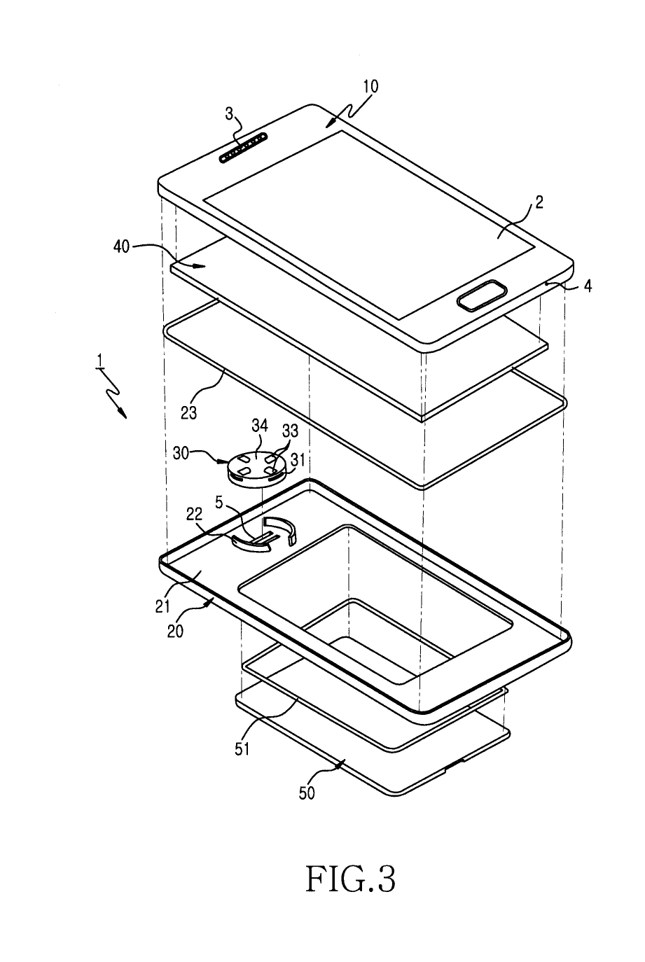

As shown in FIG. 2, a speaker sound emission hole 5 is formed in a rear surface of the portable terminal 1. The speaker sound emission hole 5 provides for the transmission of speaker sound emitted from a speaker device (see 30 of FIG. 3) installed in the portable terminal 1 to the outside of the portable terminal 1. As described above, the speaker sound emission hole 5 is installed in the rear surface of the portable terminal 1. However, the location of the speaker sound emission hole 5 is not limited to the rear surface of the portable terminal 1. The speaker sound emission hole 5 may be installed in a variety of positions such as a front surface or a side surface of the portable terminal 1 to correspond to the position of the speaker device 30 installed in the portable terminal 1.

This speaker device 30 may be used to perform a variety of audio output functions of the portable terminal 1. For example, the speaker device 30 may be applied to provide audio output for multimedia presentations such as moving pictures or games, a function for reproducing bell and alert sounds, and a function for listening to music.

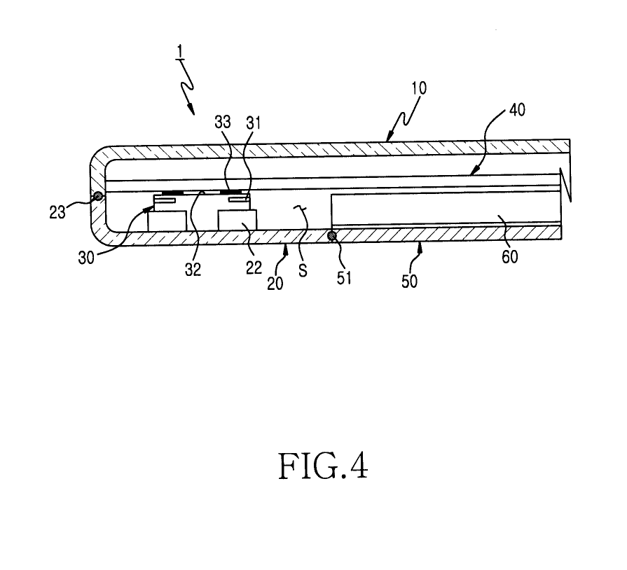

Also, a battery cover 50 is installed on the rear surface of the portable terminal 1 for providing access to an interior battery compartment of the portable terminal. When the battery cover 50 is opened, a certain battery cell (see 60 of FIG. 4) may be provided and installed as a power supply means of the portable terminal 1.

FIG. 3 is an exploded perspective view of a portable terminal showing a state where a speaker device of FIG. 1 is installed according to an exemplary embodiment of the present invention.

Referring now to FIG. 1 to FIG. 3, the portable terminal 1 in which a speaker sound resonance space (see S of FIG. 4) is provided according to an exemplary embodiment of the present invention includes the upper case frame 10 and the lower case frame 20 which is joined with the upper case frame 10 to form the exterior housing of the portable terminal 1, a board (for example a Printed Circuit Board (PCB) for providing the device electronic circuitry) 40 and a speaker device 30 which are disposed in a space disposed between the assembly of the upper case frame 10 and the lower case frame 20.

A bushing 22 which is projected and extends in an upper direction is adapted and positioned to receive the above-described speaker device 30 is formed on a specific place of a lower surface 21 of the lower case frame 20. It is preferable that this bushing 22 is formed as an integral component together with the lower case from when injection molding of the lower case frame 20 is performed. However, one skilled in the art will recognize that it is acceptable that the bushing is formed on the upper case frame 10 to secure and locate the speaker device 30. Accordingly, it is preferable that the bushing 22 is formed having a size and shape to tightly mount the speaker device 30 by a fitting type to easily assemble the speaker device 30.

A plurality of electrical connection speaker terminals 33 are provided on one surface of a speaker body 34 of the speaker device 30. When the portable terminal is assembled and the speaker device is installed, these speaker terminals 33 may be electrically connected with connection terminals of the PCB 40 for providing an audio signal from the PCB to the speaker device 30. Also, at least one air hole 31 is formed in a side surface of the speaker body 34. This air hole 31 is formed to allow for the movement of air generated and caused according to vibration of a diaphragm in the speaker body 34. As described above, while the air hole 31 is depicted in this embodiment as being formed in the side of the speaker body 34, one skilled in the art will recognize that the air hole 31 may also be formed in another surface of the speaker body 34.

In accordance with an exemplary embodiment of the present invention, the speaker device 30 may be fixed to the lower case frame 20 and the PCB 40 may be fixed to the upper case frame 10. Accordingly, when the upper case frame 10 and the lower case frame 20 are joined, the speaker terminals 33 which are installed on the speaker body 34 of the speaker device 30 fixed to the lower case frame 20 and are exposed in an upper direction depicted in FIG. 3 and may be electrically connected with the connection terminals provided on the PCB 40. Also, the battery cover 50 may also be further installed on the lower case frame 20.

Additionally, the portable terminal 1 according to an exemplary embodiment of the present invention also includes a waterproof and airtight capability. Accordingly, a certain sealing member 23 may be provided which is interposed between the upper case frame 10 and the lower case frame 20. This sealing member 23 may be a made of a material such as a well-known sealing member materials rubber and or silicon, although one skilled in the art will recognize that other materials and constructions are also possible. Also, a sealing member 51 may be applied between the lower case frame 20 and the battery cover 50.

FIG. 4 is a cross section view of a portable terminal showing a state where a speaker device of FIG. 1 is installed according to an exemplary embodiment of the present invention.

Referring now to FIG. 3 and FIG. 4, when the upper case frame 10, the lower case frame 20, the PCB 40, the speaker device 30, and the battery cover 50 are assembled, the portable terminal 1 may include a waterproof and airtight capability. Accordingly, a sealing structure where the inside of the portable terminal 1 is isolated from the outside thereof is provided. Additionally a speaker sound resonance space S is created for the speaker sound generated from the speaker device 30. The speaker sound may be emitted through the speaker sound emission hole 5. That is, the space S which has an airtight seal from the outside of the portable terminal case is perfectly sealed by the upper case frame 10, the lower case frame 20, the sealing member 23, the battery cover 50, and the sealing member 51 and thus may be used as a resonance space of the speaker device 30. The resonance space S is in communication with the air holes 31 such that air movement generated and caused according to vibration of a diaphragm in the speaker body 34 may pass through the air holes and move within the sealed resonance space. The resonance space may also be provided and include a space between the PCB 40 installed in the upper case frame 10 and the lower case frame 20.

In conclusion, the electronic apparatus according to one exemplary embodiment of the present invention does not use additional or separate components for creating a separate resonance space for the speaker device. In accordance with the present invention a resonance space of the speaker device installed in the electronic apparatus may be formed by sealing an airtight and waterproof structure within the case frame. Therefore, the electronic apparatus may save manufacturing costs and may be more compact, therefore contributing to slimness of the portable device.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An electronic apparatus comprising:
an upper case frame;
a lower case frame adapted to be joined with the upper case frame and have a sealing structure;
a speaker device fixed to an inner surface of one of the upper case frame and the lower case frame; and
a board electrically connected with speaker terminals of the speaker device when the upper case frame and the lower case frame are joined, and wherein a sealing space formed by the sealing structure creates is used as a resonance space of the speaker device.

2. The electronic apparatus of claim 1, wherein the board is fixed to one of a lower or upper case frame opposite to the other of a lower or upper case frame to which the speaker device is fixed.

3. The electronic apparatus of claim 1, wherein the resonance space is a space located between a case frame in which the speaker device is installed and the board.

4. The electronic apparatus of claim 1, wherein the speaker device is retained within a bushing, projected and formed on an inner surface of a case frame in which the speaker device is installed.

5. The electronic apparatus of claim 1, wherein the sealing space is hermetically sealed.

6. The electronic apparatus of claim 1 wherein the sealing structure, further comprises a separate sealing member which interposes between the upper case frame and the lower case frame to hermetically seal the sealing space.

7. The electronic apparatus of claim 6, wherein the sealing member is made of rubber or silicon.

8. The electronic apparatus of claim 1, wherein the electronic apparatus is a portable terminal.

9. An electronic apparatus comprising:
at least two case frames configured to have a sealing space therein when the case frames are joined and are adapted to incorporate an electronic apparatus within the at least two case frames;
a board disposed in a space formed between the case frames; and
a speaker device which is installed in one of the at least two case frames and is electrically connected with the board when the case frames are joined, wherein the sealing space formed by the case frames is used as a resonance space for the speaker device when the speaker device is operated.

10. The electronic apparatus of claim 9, further comprising a sealing member which interposes between the case frames to hermetically seal the sealing space.

11. The electronic apparatus of claim 9, wherein the case frames include an upper case frame, a lower case frame, and a battery cover removably installed in the lower case frame.

12. The electronic apparatus of claim 9, wherein the electronic apparatus is a portable terminal.

13. The electronic apparatus of claim 11, further comprising a sealing member which interposes between the lower case frame and the battery cover to hermetically seal the battery cover with the lower case frame.

14. A resonance structure for a speaker device of an electronic apparatus, the resonance structure comprising:
a first case frame;
a second case frame which is joined with the first case frame and are adapted to incorporate an electronic apparatus within the first case frame and the second case frame;
a board disposed in a space formed by the first and second case frames; and
a speaker device which is installed in one of the first and second case frames and has speaker terminals electrically connected with the board when the case frames are joined, wherein the space is formed as a sealing structure and wherein the space is used as a resonance space of the speaker device when the speaker device is operated.

15. The resonance structure of claim 14, further comprising a sealing member which interposes between the first and second case frames to hermetically seal the sealing space.

16. The resonance structure of claim 14, wherein the electronic apparatus is a portable terminal.
